(19) United States
(12) Patent Application Publication
(10) Pub. No.: US 2026/0259392 A1
(43) Pub. Date: Sep. 3, 2026

(54) LENS APPARATUS AND IMAGE PICKUP APPARATUS

(71) Applicant: CANON KABUSHIKI KAISHA, Tokyo (JP)

(72) Inventor: Takumi SUZUKI, Saitama (JP)

(21) Appl. No.: 19/546,503

(22) Filed: Feb. 23, 2026

(30) Foreign Application Priority Data
Feb. 28, 2025 (JP) 2025-031357

(51) Int. Cl. G02B 13/00; G02B 3/00; G02B 7/02

(52) U.S. Cl. CPC G02B 13/0045; G02B 7/025; G02B 13/006; G02B 2003/0093

(57) ABSTRACT

A lens apparatus including, in order from an object side to an image side: a first lens unit having a positive refractive power; a second lens unit having a negative refractive power; a third lens unit having a positive refractive power; a fourth lens unit having a positive refractive power; and a fifth lens unit having a negative refractive power, in which each distance between adjacent lens units changes during focusing, in which, the first lens unit does not move for focusing, the second lens unit and the fourth lens unit move for focusing, and in which focal lengths of the lens apparatus, the third lens unit, and the fourth lens unit are appropriately set.

### BACKGROUND

### Field of the Technology

The present disclosure relates to a lens apparatus and an image pickup apparatus.

### Description of the Related Art

In recent years, macro lenses that enable both infinite-distance shooting and close-up shooting with a magnification ratio of 1:1 have become available. In particular, for macro lenses having focal lengths ranging from standard to intermediate telephoto, a telephoto-type image pickup optical system is known. This system has an optical system having a positive refractive power on the object side and an optical system having a negative refractive power on the image side.

Japanese Patent Laid-Open Nos. 2020-060661 and 2020-064123 disclose a macro lens that includes first to fifth lens units, in order from the object side to the image side, that have positive, negative, positive, positive and negative refractive powers, respectively, and that focus using the second and fourth lens units.

In recent years, in an optical system used in an image pickup apparatus, it is strongly desired that a distance between an object and a lens (shortest image pickup distance) at a time of closest distance image pickup be short while the entire optical system is small, and in order to obtain excellent optical performance while miniaturization the entire optical system. It is important to appropriately set a refractive power and a configuration of each lens unit, a moving condition associated with focusing of each lens unit, and the like.

It is difficult to miniaturize the macro lens disclosed in Japanese Patent Laid-Open No. 2020-060661 because a refractive power of the fourth lens unit serving as a focus unit is weak with respect to the focal length of the entire system. It is difficult to miniaturize the macro lens disclosed in Japanese Patent Laid-Open No. 2020-064123 because a refractive power of the third lens unit is weak with respect to the focal length of the entire system.

### SUMMARY

Accordingly, the present disclosure provides a lens apparatus that is small in size, can perform from an infinite-distance shooting (still or motion) to a close-up shooting (still or motion) with magnification ratio of 1:1, and has high optical performance.

A lens apparatus according to one aspect of the present disclosure includes, in order from an object side to an image side: a first lens unit having a positive refractive power; a second lens unit having a negative refractive power; a third lens unit having a positive refractive power; a fourth lens unit having a positive refractive power; and a fifth lens unit having a negative refractive power, in which each distance between adjacent lens units changes during focusing,
in which, the first lens unit does not move for focusing, the second lens unit and the fourth lens unit move for focusing, and
in which the following inequalities are satisfied,

$$0. 44 < f 3 / f < 0.8$$

$$0 < f 4 / f < 0.72$$

where f represents a focal length of the lens apparatus, f3 represents a focal length of the third lens unit, and f4 represents a focal length of the fourth lens unit.

A lens apparatus according to another aspect of the present disclosure includes, in order from an object side, a first lens unit having a positive refractive power, a second lens unit having a negative refractive power, a third lens unit having a positive refractive power, a fourth lens unit having a positive refractive power, and a fifth lens unit having a negative refractive power, in which each distance between adjacent lens units changes during focusing, in which during focusing, the first lens unit does not move, the second lens unit and the fourth lens unit move.

Features of the present disclosure will become apparent from the following description of embodiments with reference to the attached drawings. The following description of embodiments is described by way of example.

### BRIEF DESCRIPTION OF THE DRAWINGS

FIG. 1 shows lens cross-sectional views of a lens apparatus according to Embodiment 1 (a) at a time of focusing on infinity and (b) at the time of focusing on the closest distance, respectively.

FIG. 2A is an aberration diagram of the lens apparatus according to Embodiment 1 at the time of focusing on infinity.

FIG. 2B is an aberration diagram of the lens apparatus according to Embodiment 1 at the time of focusing on closest distance.

FIG. 3 shows lens cross-sectional views of the lens apparatus according to Embodiment 2 (a) at the time of focusing on infinity and (b) at the time of focusing on closest distance, respectively.

FIG. 4A is an aberration diagram of the lens apparatus according to Embodiment 2 at the time of focusing on infinity.

FIG. 4B is an aberration diagram of the lens apparatus according to Embodiment 2 at the time of focusing on closest distance.

FIG. 5 shows lens cross-sectional views of the lens apparatus according to Embodiment 3 (a) at the time of focusing on infinity and (b) at the time of focusing on closest distance, respectively.

FIG. 6A is an aberration diagram of the lens apparatus according to Embodiment 3 at the time of focusing on infinity.

FIG. 6B is an aberration diagram of the lens apparatus according to Embodiment 3 at the time of focusing on closest distance.

FIG. 7 shows lens cross-sectional views of the lens apparatus according to Embodiment 4 (a) at the time of focusing on infinity and (b) at the time of focusing on the closest distance, respectively.

FIG. 8A is an aberration diagram of the lens apparatus according to Embodiment 4 at the time of focusing on infinity.

FIG. 8B is an aberration diagram of the lens apparatus according to Embodiment 4 at the time of focusing on closest distance.

FIG. 9 is a schematic diagram of a main part of an image pickup apparatus according to Embodiment.

### DESCRIPTION OF THE EMBODIMENTS

Hereinafter, the preferred embodiments of the present disclosure will be described in detail with reference to the accompanying drawings.

The lens apparatus of each embodiment is an image pickup lens apparatus used in an image pickup apparatus such as a still camera, a video camera, a digital still camera, a silver-halide film camera, a TV camera, an in-vehicle camera, or a monitoring camera. The lens apparatus of each embodiment can also be used as a projection optical system for a projection apparatus (projector).

In recent years, macro lenses that enable both from an infinite-distance shooting to a close-up shooting with magnification ratio of 1:1 have become known. Particularly for macro lenses having focal lengths ranging from standard to intermediate telephoto, a so-called telephoto-type image pickup optical system is known in which an optical element with positive refractive power is disposed on the object side and an optical element having a negative refractive power is disposed on the image side. Telephoto-type optical systems are used in the telephoto lens in zoom lenses, for example.

Further, in digital cameras and video cameras, the number of pixels of solid-state image pickup elements such as CCDs and CMOS sensors has been increased, and high optical performance including chromatic aberration has been required for image pickup lenses and miniaturization has been advanced.

In recent years, in an optical system used in an image pickup apparatus, it is strongly desired that a distance between an object and a lens (shortest image pickup distance) at the time of picking up an image of closest distance is short while the entire optical system is miniaturized. To achieve compactness across the entire optical system while maintaining excellent optical performance, it is important to appropriately set the refractive power and configuration of each lens unit, as well as the movement conditions associated with focusing for each lens unit. This disclosure aims to provide a lens apparatus that is compact yet delivers high optical performance from infinity to the closest focusing distance.

The lens apparatus according to the present disclosure includes, in order from the object side to the image side, a first lens unit L1 having a positive refractive power (an optical power equivalent to a reciprocal of a focal length), a second lens unit L2 having a negative refractive power, a third lens unit having a positive refractive power, a fourth lens unit L4 having a positive refractive power, and a fifth lens unit L5 having a negative refractive power, and each distance between adjacent lens units changes during focusing.

In focusing from infinity to close distance, the second lens unit L2 moves toward the image side and the fourth lens unit L4 moves toward the object side in the optical axis direction, and the first lens unit L1 does not move for focusing.

In order to achieve the above object, in the lens apparatus according to the present disclosure, the following inequalities are satisfied,

$$0.44 < f 3 / f < 0.8 \qquad ( 1 )$$

$$0 < f 4 / f < 0.72 \qquad ( 2 )$$

where f represents a focal length of the entire system, f3 represents a focal length of the third lens unit, and f4 represents a focal length of the fourth lens unit.

To satisfactorily achieve aberration correction across the entire focusing range, the focusing lens units are constituted by the second lens unit L2 having a negative refractive power disposed on the object side of the aperture stop SP and the fourth lens unit L4 having a positive refractive power disposed on the image side of the aperture stop SP. This arrangement enables the second lens group L2 to suppress fluctuations in spherical aberration and chromatic aberration associated with focusing, while the fourth lens group L4 suppresses fluctuations in the curvature of field and chromatic aberration.

Since the first lens unit L1 has a positive lens disposed closest to the object side. Placing a positive lens closest to the object side provides an advantage for correcting axial chromatic aberration. Furthermore, within the first lens unit L1, at least two positive lenses are arranged consecutively from the most object side toward the image side. This configuration enables effective convergence of the axial beam, allowing for system miniaturization while providing excellent correction for various on-axis aberrations such as spherical aberration and coma.

The second lens unit L2 has at least two negative lenses. This configuration enables the second lens unit L2, which is the focusing lens unit, to be made lighter while facilitating the incidence of beams entering the third lens unit L3 parallel to the optical axis. This suppresses fluctuations in spherical aberration associated with focusing.

The third lens unit L3 has one positive lens disposed closest to the image side. This configuration enables effective convergence of the axial beam, allowing for overall system miniaturization. Furthermore, when a part of the third lens unit L3 is designated as an anti-vibration lens unit, it suppresses variations in coma and curvature of field caused by anti-vibration.

The fourth lens unit L4 has at least one positive lens. This configuration enables effective convergence of the axial beam, allowing for overall system miniaturization while suppressing fluctuations in various aberrations such as curvature of field and chromatic aberration of magnification associated with focusing.

The fifth lens unit L5 has a negative lens disposed closest to the object side. Having the negative lens arranged closest to the object side in the fifth lens unit L5 enables effective divergence of off-axial beams, which is beneficial for miniaturizing the entire system. Furthermore, when the fifth lens unit L5 has at least two negative lenses, it can more effectively correct various off-axis aberrations such as chromatic aberration of magnification and distortion.

The inequality (1) regulates the ratio of the focal length f of the entire system to the focal length f3 of the third lens unit L3, aiming to achieve both the miniaturization of the entire system and the correction of the optical performance. If the upper limit of the inequality (1) is not satisfied, the refractive power of the third lens unit L3 decreases, which is beneficial for suppressing spherical aberration and axial chromatic aberration generated in the axial beams. However, this results in an increase in the overall system size, which is undesirable. Conversely, if the lower limit of the inequality (1) is exceeded, the refractive power of the third lens unit L3 increases. This is beneficial for miniaturizing the entire system. However, this makes it difficult to suppress spherical aberration and axial chromatic aberration, which is undesirable.

Inequality (2) regulates the ratio of the focal length f of the entire system to the focal length f4 of the fourth lens unit L4. It is a condition for suppressing changes in optical performance due to focusing and miniaturization of the entire system.

If the upper limit of the inequality (2) is not satisfied, the refractive power of the fourth lens unit L4, the focusing lens unit, decreases. This is not preferable because the movement distance of the fourth lens unit L4 during focusing increases, which leads to a larger entire system while which makes it easier to suppress the variations in curvature of field and chromatic aberration of magnification associated with the focusing. If the lower limit of inequality (2) is not satisfied, the refractive power of the fourth lens unit L4, the focusing lens unit, increases. This shortens the movement distance of the fourth lens unit L4 during focusing, which is beneficial for miniaturizing the entire system. However, it becomes difficult to suppress fluctuations in curvature of field and chromatic aberration of magnification during focusing, making this condition undesirable.

In each embodiment, the numerical ranges of the inequalities (1) and (2) are preferably set as follows.

$$0. 46 < f 3 / f < 0 \text{.79} \qquad ( 1 a )$$

$$0.15 < f 4 / f < 0.70 \qquad ( 2 a )$$

By satisfying the inequality (1a), it is easy to suppress the axial chromatic aberration generated by the axial beam at the time of focusing on closest distance. By satisfying inequality (2a), it becomes easier to achieve both the chromatic aberration of magnification generated by the off-axial beam at the time of focusing on closest distance and the miniaturization of the entire system.

More preferably, the numerical ranges of the inequalities (1a) and (2a) are set as follows.

$$0. 48 < f 3 / f < 0 \text{.78} \qquad ( 1 b )$$

$$0.3 < f 4 / f < 0.68 \qquad ( 2 b )$$

By appropriately configuring each lens unit as described above and satisfying the inequalities (1) and (2), it is possible to achieve ranging from the infinite-distance shooting to the close-up shooting with magnification ratio of 1:1. This enables the realization of a lens apparatus having entire system being small with high optical performance.

In each Embodiment, it is more preferable to satisfy one or more of the following inequalities (3) to (16).

$$- 0.50 < f 5 / f < - 0.15 \qquad ( 3 )$$

$$- 0.8 \; 5 < f 5 / f 3 < - 0.3 \qquad ( 4 )$$

$$- 0.8 \; 0 < f 5 / f 4 < - 0.3 \qquad ( 5 )$$

$$0.65 < f 3 / f 4 < 2. \qquad ( 6 )$$

$$- 0.8 \; 0 < f 2 / f 3 < - 0.35 \qquad ( 7 )$$

$$0 < f / \vert f 12 \vert < 0.3 \qquad ( 8 )$$

$$0. 40 < f 3 B / f 3 A < 5. \qquad ( 9 )$$

$$0.8 < f 5 A / f 5 < 1.6 \qquad ( 10 )$$

$$6. < sk / TL < 14. \qquad ( 11 )$$

$$0.9 < MD 2 / TL < 1.8 \qquad ( 12 )$$

$$0.8 < MD 4 / TL < 1.6 \qquad ( 13 )$$

$$- 5. < ES 2 < - 3. \qquad ( 14 )$$

$$2. < ES 4 < 3.5 \qquad ( 15 )$$

$$0.7 < G 5 ASF < 2.00 \qquad ( 16 )$$

Here, f2 represents a focal length of the second lens unit L2, f5 represents a focal length of the fifth lens unit L5, and f12 represents a combined focal length of the first lens unit L1 and the second lens unit L2 at the time of focusing on infinity. f3A represents a focal length of a lens element G3A disposed at the most-object side in the third lens unit L3. f3B represents a focal length of all lens elements G3B located in the image side of the lens element G3A in the third lens unit L3. f5A represents a focal length of the lens element G5A disposed at the most object-side in the fifth lens unit L5. sk represents a back focus at the time of focusing on infinity, and TL represents an entire optical length of the entire system. MD2 represents a distance of a movement of the second lens unit L2 along the optical axis during focusing on from infinity to the closest distance. MD4 represents a distance of a movement of the fourth lens unit L4 along the optical axis during focusing on from infinity to the closest distance. ES2 represents a focus sensitivity of the second lens unit L2 at the time of focusing on infinity, and ES4 represents a focus sensitivity of the fourth lens unit L4 at the time of focusing on infinity. G5ASF represents a shape factor of the lens element G5A disposed at the most object-side in the fifth lens unit L5.

The shape factor SF is a shape factor of the lens L and is expressed by the following expression,

$$S F = sgn ( fL ) \times ( R 2 + R 1 ) / ( R 2 - R 1 )$$

where fL represents a focal length of the lens L, R1 represents a curvature radius of the object-side surface, and R2 represents a curvature radius of the image-side surface. In the case of aspherical shape, it denotes the radius of the reference quadratic surface. sgn(fL) represents a sign function which gives a value, 1, when fL is a positive value and −1 when fL is a negative value.

The Abbe number vd is obtained by the following expression,

$$v d = ( Nd - 1 ) / ( NF - NC )$$

where Nd, NF, and NC represent refractive indexes at d-line, F-line, and C-line of the Fraunhofer line, respectively.

Here, the back focus refers to a distance from the vertex of the lens surface disposed at the most image-side to the image plane. When an optical element with extremely low refractive power is disposed between the lens apparatus and the image pickup element, the back focus shall use a value with the optical element with extremely low refractive power disposed between the lens apparatus and the image pickup element being treated as an equivalent air distance.

In addition, the focus sensitivity ESi is defined as follows,

$$ESi = ( 1 - β {i}^{2} ) \times β {r}^{2}$$

where βi represents a lateral magnification of the moving lens unit i and βr represents a lateral magnification of the lens unit r disposed in the image side of the moving lens unit i at the time of focusing on infinity.

The inequality (3) defines a ratio of the focal length f5 of the fifth lens unit L5 to the focal length f of the entire system, aiming to achieve both miniaturization of the entire system and obtaining high optical performance.

If the upper limit of the inequality (3) is not satisfied, it is beneficial for miniaturization, but it is not preferable because it is difficult to correct aberrations such as spherical aberration occurring in the positive lens unit disposed in the object side of the fifth lens unit L5.

If the lower limit of the inequality (3) is not satisfied, it is beneficial for suppressing the distortion and chromatic aberration of magnification, which are mainly generated in an off-axial beam. However, it is not preferable because the telephoto effect is weakened, and the total optical length of the entire system increases.

The inequality (4) defines a ratio of the focal length f5 of the fifth lens unit L5 to the focal length f3 of the third lens unit L3, aiming to achieve both miniaturization of the entire system and obtaining high optical performance.

If the upper limit of the inequality (4) is not satisfied, it is beneficial for suppressing curvature of field and chromatic aberration of magnification, which are mainly generated by off-axial beam. However, it is not preferable because the telephoto effect is weakened, and the total optical length of the entire system increases.

If the lower limit of the inequality (4) is not satisfied, it is beneficial that the telephoto effect is enhanced, and the total optical length of the entire system is shortened. However, it is not preferable because it is difficult to suppress spherical aberration and axial chromatic aberration that mainly occur in the axial beam.

The inequality (5) defines a ratio of the focal length f5 of the fifth lens unit L5 to the focal length f4 of the fourth lens unit L4, aiming to achieve both miniaturization of the entire system and obtaining high optical performance.

If the upper limit of the inequality (5) is not satisfied, it is beneficial for suppressing curvature of field and chromatic aberration of magnification mainly generated by off-axial beam. However, it is not preferable because the telephoto effect is weakened, and the overall optical length of the entire system increases.

If the lower limit of the inequality (5) is not satisfied, it is beneficial that the telephoto effect is enhanced, and the total optical length of the entire system is shortened. However, it is not preferable because it is difficult to suppress spherical aberration and axial chromatic aberration generated mainly in the axial beam.

The inequality (6) defines a ratio between the focal length f3 of the third lens unit L3 to the focal length f4 of the fourth lens unit L4, aiming to achieve both miniaturization of the entire system and obtaining high optical performance.

If the upper limit of the inequality (6) is not satisfied, it is not preferable because it is necessary to shorten the focal length f4 of the fourth lens unit L4, the focus lens unit, aiming to achieve miniaturization, and it becomes difficult to suppress the fluctuation of the curvature of field and the chromatic aberration of magnification at the time of focusing, which is not preferable.

If the lower limit of the inequality (6) is not satisfied, it is beneficial for miniaturization, but it is not preferable because it makes it difficult to suppress spherical aberration and axial chromatic aberration, which occur mainly in an axial beam.

The inequality (7) defines a ratio of the focal length f2 of the second lens unit L2 to the focal length f3 of the third lens unit L3, aiming to achieve both miniaturization of the entire system and obtaining high optical performance.

If the upper limit of the inequality (7) is not satisfied, it is beneficial for suppressing the fluctuation of spherical aberration at the time of focusing. However, it is not preferable because the movement distance of the second lens unit L2, the focus lens unit, at the time of focusing becomes long and the total optical length of the entire system becomes long.

If the lower limit of the inequality (7) is not satisfied, the movement distance of the second lens unit L2, which is the focus lens unit, at the time of focusing becomes short and the entire optical length of the entire system becomes short, which is beneficial for miniaturization. However, it is not preferable because it becomes difficult to suppress the fluctuation of the spherical aberration at the time of focusing.

The inequality (8) defines a ratio of the focal length f of the entire system and an absolute value of the combined focal length f12 of the first lens unit L1 and the second lens unit L2 at the time of focusing on infinity, aiming to achieve both miniaturization of the entire system and obtaining high optical performance.

If the upper limit of the inequality (8) is not satisfied, it is beneficial for miniaturization, but it is not preferable because it is difficult to suppress various aberrations such as spherical aberration generated in the first lens unit L1 and the second lens unit L2. If a part or all the third lens unit L3 is used as an anti-vibration lens unit, the angle of the light beam entering the third lens unit L3 becomes steep, making it difficult to ensure the optical performance at the time of focusing, which is undesirable.

If the lower limit of the inequality (8) is not satisfied, although it is beneficial for suppressing various aberrations such as spherical aberration occurring in the first lens unit L1 and the second lens unit L2, miniaturization becomes difficult, which is not preferable.

The inequality (9) defines a ratio between the focal length f3A of the lens element G3A disposed at the most object side and the focal length f3B of all the lens elements G3B disposed in the image side of the lens element G3A in the third lens unit L3, aiming to achieve both miniaturization of the entire system and obtaining high optical performance.

If the upper limit of the inequality (9) is not satisfied, it is not preferable even it is beneficial for securing the optical performance at the time of focusing in the case where the lens element G3A is used as the anti-vibration lens unit, because it is difficult to realize miniaturization.

If the lower limit of the inequality (9) is not satisfied, it is beneficial for miniaturization, but it is not preferable because it is difficult to suppress various aberrations such as spherical aberration generated in the lens element G3B.

The inequality (10) defines a ratio of the focal length f5A of the lens element G5A disposed at the most object side in the fifth lens unit L5 to the focal length f5 of the fifth lens unit L5, aiming to achieve both miniaturization of the entire system and obtaining high optical performance.

If the upper limit of the inequality (10) is not satisfied, an effect of bending the off-axial beam away from the optical axis becomes weaker, which is beneficial for suppressing distortion and chromatic aberration of magnification, but it is not preferable because miniaturization becomes difficult.

If the lower limit of the inequality (10) is not satisfied, the effect of bending the off-axial beam away from the optical axis becomes stronger, which is beneficial for miniaturization, but it becomes difficult to suppress distortion and chromatic aberration of magnification, which is not preferable.

The inequality (11) defines a ratio of the back focus sk at the time of focusing on infinity to the total optical length TL of the entire system at the time of focusing on infinity, aiming to achieve both miniaturization of the entire system and securing of the moving distance of the focus lens unit.

If the upper limit of the inequality (11) is not satisfied, the degree of freedom in arranging the mechanical member in the mount portion is improved, but it is difficult to secure the moving distance of the focus lens unit, which is not preferable.

If the lower limit of the inequality (11) is not satisfied, it becomes easy to secure the moving distance of the focus lens unit, but it becomes difficult to appropriately dispose the mechanical member in the mount portion, which is not preferable.

The inequality (12) defines a ratio of the distance MD2 in which the second lens unit L2 moves along the optical axis when focusing from infinity to the closest distance to the total optical length TL of the entire system, aiming to achieve both miniaturization of the entire system and suppression of a change in optical performance at the time of focusing.

If the upper limit of the inequality (12) is not satisfied, it is beneficial for suppressing fluctuations in various aberrations such as spherical aberration at the time of focusing, but this leads to an increase in the size of the entire system, which is not preferable.

If the lower limit of the inequality (12) is not satisfied, it is beneficial for miniaturization of the entire system, but it is difficult to suppress fluctuations in various aberrations such as field curvature at the time of focusing, which is not preferable.

The inequality (13) defines a ratio of a distance MD4 in which the fourth lens unit L4 moves along the optical axis at the time of focusing from infinity to the closest distance to the total optical length TL of the entire system, aiming to achieve both miniaturization of the entire system and suppression of a change in optical performance at the time of focusing.

If the upper limit of the inequality (13) is not satisfied, it is beneficial for suppressing fluctuations in various aberrations such as curvature of field at the time of focusing, but this leads to an increase in the size of the entire system, which is not preferable.

If the lower limit of inequality (13) is not satisfied, it is beneficial for miniaturization of the entire system, but it is difficult to suppress fluctuations in various aberrations such as spherical aberration at the time of focusing, which is not preferable.

The inequality (14) is a inequality regarding the focus sensitivity ES2 of the second lens unit L2 at the time of focusing on infinity, aiming to achieve both miniaturization of the entire system and suppression of a change in optical performance due to focusing.

If the upper limit of the inequality (14) is not satisfied, it becomes easy to miniaturize the lens apparatus at the time of focusing on infinity, but it is difficult to suppress fluctuations in curvature of field and distortion mainly caused by off-axial rays at the time of focusing, and it is difficult to control the focus lens unit with high accuracy, which is not preferable.

If the lower limit of the inequality (14) is not satisfied, it is beneficial for suppressing the fluctuation of the optical performance at the time of focusing, but it is not preferable because it becomes difficult to miniaturize the lens apparatus and operate the focus lens unit at a high speed.

The inequality (15) is a inequality regarding the focus sensitivity ES4 of the fourth lens unit L4 at the time of focusing on infinity, aiming to achieve both miniaturization of the entire system and suppression of a change in optical performance due to focusing.

If the upper limit of the inequality (15) is not satisfied, it becomes easy to miniaturize the lens apparatus at the time of focusing on infinity, but it is difficult to suppress fluctuations in curvature of field and distortion mainly caused by off-axial rays at the time of focusing, and it is difficult to control the focus lens unit with high accuracy, which is not preferable.

If the lower limit of the inequality (15) is not satisfied, it is beneficial for suppressing the fluctuation of the optical performance at the time of focusing, but it is not preferable because it becomes difficult to miniaturize the lens apparatus and operate the focus lens unit at a high speed.

The inequality (16) defines the shape factor G5ASF of the lens component constituting the third lens unit L3, aiming to achieve the miniaturization and suppression of change in optical performance at the time of focusing. When the value of the inequality (16) is −1 and the lens component has a negative refractive power, the lens component has a plano-concave shape with a concave surface facing the object side.

If the upper limit of the inequality (16) is not satisfied, the curvature of the object side surface of the lens component becomes large, and it becomes easy to suppress the fluctuation of the spherical aberration generated in the axial beam on the object side surface at the time of focusing, but the lens shape becomes a biconcave shape, which makes it difficult to suppress the field curvature generated in the off-axial beam at the time of focusing, which is not preferable.

If the lower limit of the inequality (16) is not satisfied, the curvature of the object side surface of the lens component becomes small, which makes it difficult to suppress the fluctuation of the spherical aberration generated in the axial beam due to focusing, which is not preferable. Further, the curvature becomes small, which makes it difficult to process and form the lens, which is also not preferable.

It is desirable that the first lens unit L1 has two or more positive lenses and one negative lens in order from the object side, so that the degree of freedom in selecting the glass material of the positive lens is increased and various aberrations such as chromatic aberration of magnification can be satisfactorily corrected.

The second lens unit L2 is disposed on the object side of the aperture stop SP, and preferably has two or more negative lenses and one positive lens, so that the light beam converged by the first lens unit L1 can be diverged, and the light beam can be afocally incident on the third lens unit L3, which makes it easy to suppress the fluctuation of the spherical aberration due to the focusing.

In addition, it is desirable that the second lens unit L2 have an aspherical lens having a negative refractive power disposed at the most object side, which makes it easy to realize miniaturization while effectively correcting the fluctuation of the curvature of field due to focusing. However, while having two or more aspherical lenses offers advantages in correcting curvature of field and distortion, it makes lens fabrication difficult and ensures optical performance challenging, making it undesirable.

The aperture stop SP should preferably be disposed between the second lens unit L2 and the third lens unit L3. This allows the exit pupil to be placed on the object side, facilitating the miniaturization of the entire system. Furthermore, since a large number of lenses can be disposed on the image side of the aperture stop SP, it is possible to easily suppress fluctuations in curvature of field and chromatic aberration of magnification caused mainly by off axial rays.

The third lens unit L3 is preferably disposed in the image side of the aperture stop SP and consists of a cemented lens composed of one positive lens and one negative lens, and one positive lens. This configuration facilitates the suppression of the spherical aberration, and the axial chromatic aberration generated mainly by the axial beam, while also enabling the miniaturization of the front system.

The fourth lens unit L4 preferably include at least one positive lens and one negative lens. This enables suppression of fluctuation in the curvature of field and the chromatic aberration of magnification caused mainly by the off-axial beams.

The fifth lens unit L5 preferably includes a negative lens on the most object side. This allows effective divergence of the off-axial beam, making it easier to achieve both a lighter fourth lens unit L4 serving as the focus lens unit and the miniaturization of the entire system. It is also preferable that the fifth lens unit L5 includes at least two negative lenses and at least one positive lens. This allows for effective correction of various aberrations such as distortion and chromatic aberration of magnification.

Furthermore, fixing the fifth lens unit L5 relative to the image plane during focusing reduces issues such as dust accumulation that arise when removing interchangeable lenses, making it easier to ensure durability. Additionally, it is desirable to provide a lens having a convex shape on the image side on the most image side. This configuration makes securing back focus relatively easy and suppresses the collection of unnecessary light (ghosting) caused by the image pickup element.

In each lens apparatus of the embodiments, anti-vibration may be achieved by moving the entire or a part of any of the lens units as an anti-vibration lens unit in a direction including a component in a direction perpendicular to the optical axis, or by rotating it (oscillating) in a direction within the plane containing the optical axis. Particularly in the lens apparatuses of Embodiments 1 to 4, it is preferable to move the entire third lens unit L3 or a portion thereof in a direction containing a component perpendicular to the optical axis to perform anti-vibration. It is further preferable to perform anti-vibration on the lens element disposed at the most object side in the third lens unit L3.

There is no particular restriction on the number and shape of the lenses of the anti-vibration lens. It is also preferable for the anti-vibration lens unit to be a cemented lens composed of one positive lens and one negative lens.

The lens apparatus in each embodiment preferably does not include a diffractive optical element. While incorporating a diffractive optical element into the lens apparatus offers advantages from the perspective of chromatic aberration correction, it is not preferable because diffraction flare occurs in the diffractive optical element.

More preferably, the numerical range of the inequalities (3) to (16) is set as follows.

$$- 0.45 < f 5 / f < - 0.2 \qquad ( 3 a )$$

$$- 0.8 \; 0 < f 5 / f 3 < - 0.35 \qquad ( 4 a )$$

$$- 0.7 \; 5 < f 5 / f 4 < - 0.35 \qquad ( 5 a )$$

$$0.7 < f 3 / f 4 < 1.9 \qquad ( 6 a )$$

$$- 0.7 \; 5 < f 2 / f 3 < - 0.4 \qquad ( 7 a )$$

$$0.02 < f / \vert f 12 \vert < 0.25 \qquad ( 8 a )$$

$$0.5 < f 3 B / f 3 A < 4.8 \qquad ( 9 a )$$

$$0.85 < f 5 A / f 5 < 1.55 \qquad ( 10 a )$$

$$7. < sk / TL < 13. \qquad ( 11 a )$$

$$0.95 < MD 2 / TL < 1.7 \qquad ( 12 a )$$

$$0.9 < MD 4 / TL < 1.5 \qquad ( 13 a )$$

$$- 4.5 \; 0 < ES 2 < - 3.4 \qquad ( 14 a )$$

$$2.4 < ES 4 < 3.2 \qquad ( 15 a )$$

$$0.75 < G 5 ASF < 1.8 \qquad ( 16 a )$$

More preferably, when the numerical range of the inequalities (3a) to (16a) is set as follows, the above-described effects are synergistic with each other, which is even better.

$$- 0.4 < f 5 / f < - 0.23 \qquad ( 3 b )$$

$$- 0.7 \; 7 < f 5 / f 3 < - 0.37 \qquad ( 4 b )$$

$$- 0.7 \; 3 < f 5 / f 4 < - 0.38 \qquad ( 5 b )$$

$$0.72 < f 3 / f 4 < 1.85 \qquad ( 6 b )$$

$$- 0.7 \; 2 < f 2 / f 3 < - 0.43 \qquad ( 7 b )$$

$$0.03 < f / \vert f 12 \vert < 0.22 \qquad ( 8 b )$$

$$0.6 < f 3 B / f 3 A < 4.6 \qquad ( 9 b )$$

$$0.9 < f 5 A / f 5 < 1.5 \qquad ( 10 b )$$

$$8. < sk / TL < 12.5 \qquad ( 11 b )$$

$$1. 00 < MD 2 / TL < 1.65 \qquad ( 12 b )$$

$$0.95 < MD 4 / TL < 1.45 \qquad ( 13 b )$$

$$- 4.3 \; 0 < ES 2 < - 3.7 \qquad ( 14 b )$$

$$2.6 < ES 4 < 3. \qquad ( 15 b )$$

$$0.8 < G 5 ASF < 1.7 \qquad ( 16 b )$$

Hereinafter, embodiments 1 to 4 of a lens apparatus according to the present disclosure will be described with reference to the accompanying drawings.

### Embodiment 1

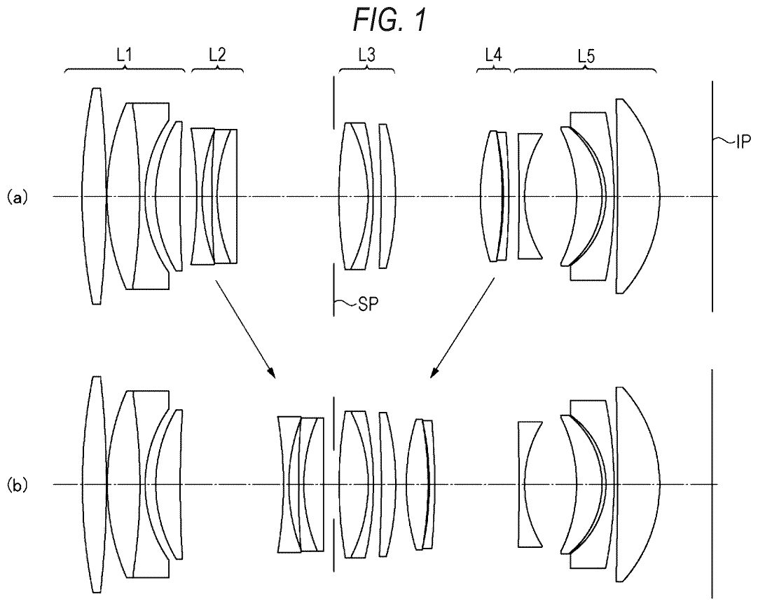

FIG. 1 shows cross-sectional views of the lens apparatus of Embodiment 1 at the time of (a) focusing on infinity and (b) at the time of focusing on the closest distance (imaging magnification β: −1.0). In the cross-sectional view of the lens apparatus, the left side is the object side (front side), and the right side is the image side (rear side). In the lens cross-sectional views, Li represents i-th lens unit where i represents the order of the lens units when counting from the object side, an arrow shown in the cross-sectional view of each lens apparatus indicates the movement direction of the lens units at the time of focusing from infinity to a close distance.

SP is an aperture stop for determining (limiting) a light beam in the open F-number (Fno). IP represents the image plane where an image pickup surface of a solid-state image pickup element (photoelectric conversion element) such as a CCD sensor or a CMOS sensor is placed when the lens apparatus is used as an image pickup optical system of a video camera or a digital still camera. Furthermore, when the lens apparatus is used as the imaging optical system for a silver-halide film cameras, the photosensitive surface corresponding to the film surface is positioned. The same applies in the following embodiments.

The lens apparatus of Embodiment 1 includes, in order from the object side to the image side, a first lens unit L1 having a positive refractive power, a second lens unit L2 having a negative refractive power, a third lens unit L3 having a positive refractive power, a fourth lens unit L4 having a positive refractive power, and a fifth lens unit L5 having a negative refractive power. The lens apparatus of Embodiment 1 has an aperture ratio of about 2.9.

In focusing from infinity to a close distance, the second lens unit L2 moves toward the image side and the fourth lens unit L4 moves toward the object side along different loci. The first lens unit L1 does not move for focusing.

The first lens unit L1 is composed of, in order from the object side to the image side, a positive lens, a cemented lens composed of a positive lens and a negative lens, and a meniscus positive lens convex to the object side.

The second lens unit L2 is composed of, in order from the object side to the image side, a negative lens, and a cemented lens composed of a meniscus negative lens convex to the object side and a meniscus positive lens convex to the object side.

The third lens unit L3 is composed of, in order from the object side to the image side, a cemented lens composed of a positive lens and a meniscus negative lens concave to the object side, and a meniscus positive lens concave to the object side.

The fourth lens unit L4 is composed of, in order from the object side to the image side, a positive lens and a meniscus negative lens concave to the object side.

The fifth lens unit L5 is composed of, in order from the object side to the image side, a negative lens, a meniscus positive lens concave to the object side, a meniscus negative lens concave to the object side, and a meniscus positive lens concave to the object side.

An aperture stop SP is disposed adjacent to the object side of the third lens unit L3.

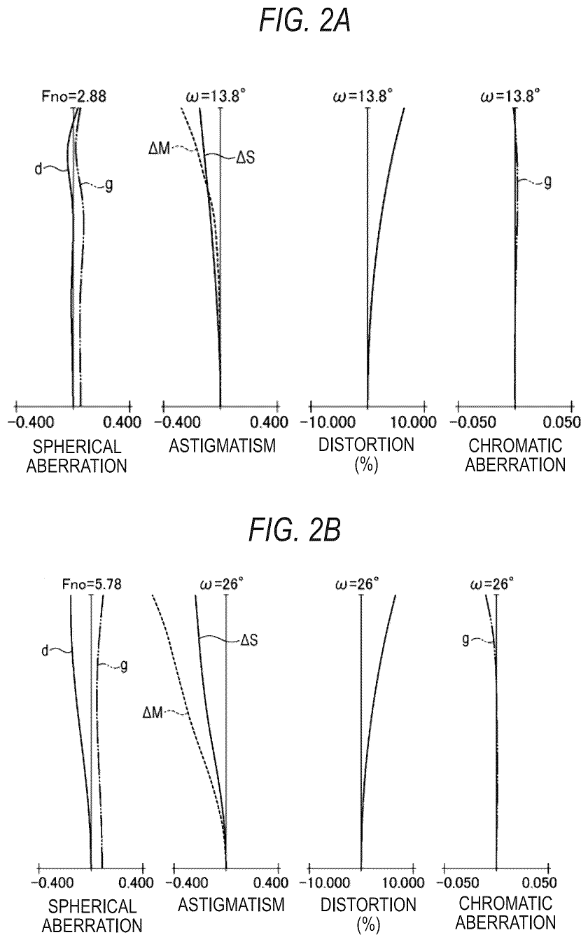

FIGS. 2A and 2B are aberration diagrams of the lens apparatus of Embodiment 1 at the time of focusing on infinity and at the time of focusing on the closest distance (image pickup magnification β=−1.0).

In the aberration diagram, Fno represents a F-number, ω represents a half angle of view (degree), those are obtained through an optical ray tracing. In the spherical aberration diagram, d represents d-line (wavelength: 587.56 nm) and g represents g-line (wavelength: 435.835 nm). In the astigmatism diagram, ΔS represents an aberration on a sagittal image surface for d-line, ΔM represents an aberration on a meridional image surface for d-line. The distortion diagram is given for d-line. g represents a g-line in the aberration diagram of the chromatic aberration of magnification. All aberrations are satisfactorily corrected.

Numerical values in Embodiment 1 corresponding to the inequalities (1) to (16) are shown in Table 1. The lens apparatus according to Embodiment 1 satisfies the inequalities (1) to (16), is small in size, can perform from the infinite-distance shooting to the close-up shooting with magnification ratio of 1:1, and has high optical performance.

### Embodiment 2

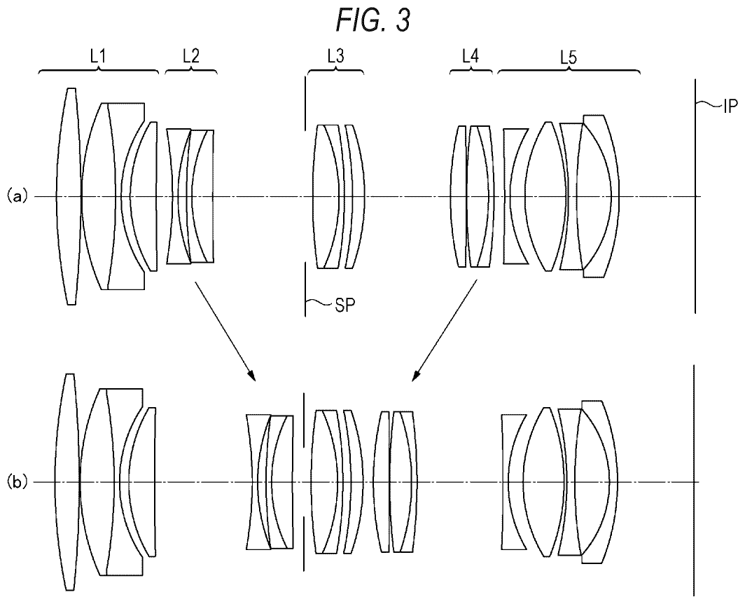

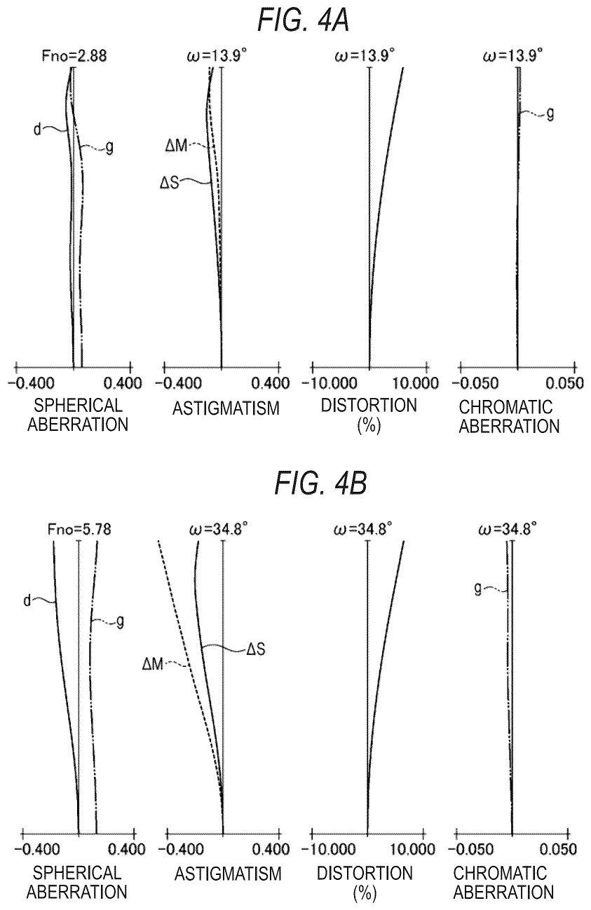

FIG. 3 shows cross-sectional views of the lens apparatus of Embodiment 2 at (a) the time of focusing on infinity and (b) the time of focusing on closest distance (image pickup magnification β=−1.0). FIGS. 4A and 4B are aberration diagrams of the lens apparatus of Embodiment 2 at the time of focusing on infinity and at the time of focusing on closest distance (imaging magnification β=−1.0), respectively. The lens apparatus of Embodiment 2 is a lens apparatus with an aperture ratio of about 2.9.

The lens apparatus of Embodiment 2 includes, in order from the object side to the image side, a first lens unit L1 having a positive refractive power, a second lens unit L2 having a negative refractive power, a third lens unit L3 having a positive refractive power, a fourth lens unit L4 having a positive refractive power, and a fifth lens unit L5 having a negative refractive power.

In focusing from infinity to a close distance, the second lens unit L2 moves toward the image side and the fourth lens unit L4 moves toward the object side along different loci. The first lens unit L1 does not move for focusing.

The first lens unit L1 is composed of, in order from the object side to the image side, a positive lens, a cemented lens composed of a positive lens and a negative lens, and a meniscus positive lens convex to the object side.

The second lens unit L2 is composed of, in order from the object side to the image side, a negative lens, and a cemented lens composed of a meniscus negative lens convex to the object side and a meniscus positive lens convex to the object side.

The third lens unit L3 is composed of, in order from the object side to the image side, a cemented lens composed of a positive lens and a meniscus negative lens concave to the object side, and a meniscus positive lens concave to the object side.

The fourth lens unit L4 is composed of, in order from the object side to the image side, a positive lens and a cemented lens composed of a positive lens and a meniscus negative lens concave to the object side.

The fifth lens unit L5 is composed of, in order from the object side to the image side, a negative lens, a positive lens, a negative lens, and a meniscus negative lens concave to the object side.

An aperture stop SP is disposed adjacent to the object side of the third lens unit L3.

Each of FIGS. 4A and 4B shows aberration diagrams at the time of focusing on infinity and at the time of focusing on the closest distance (image pickup magnification β=−1.0) of the lens apparatus of Embodiment 2, and all aberrations are satisfactorily corrected.

Numerical values in Embodiment 2 corresponding to the inequalities (1) to (16) are shown in Table 1. The lens apparatus according to Embodiment 2 satisfies the inequalities (1) to (16), is small in size, can perform from the infinite-distance shooting to the close-up shooting with magnification ratio of 1:1, and has high optical performance.

### Embodiment 3

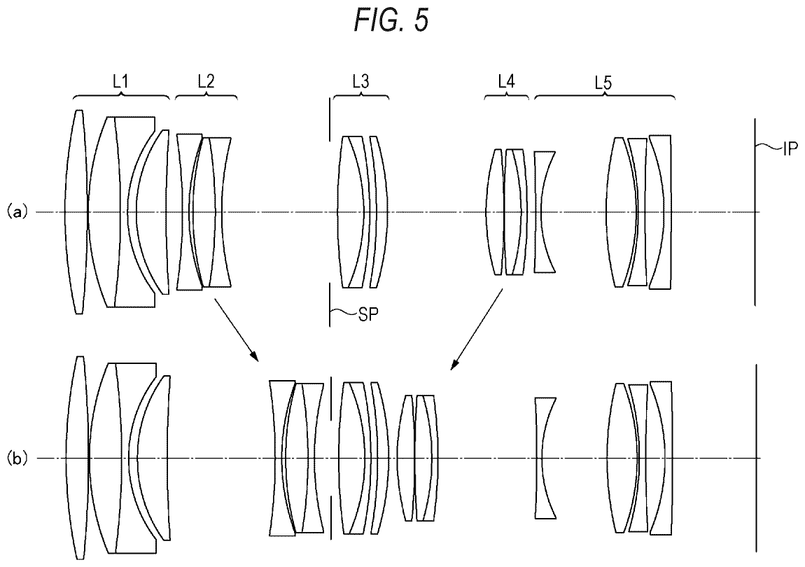

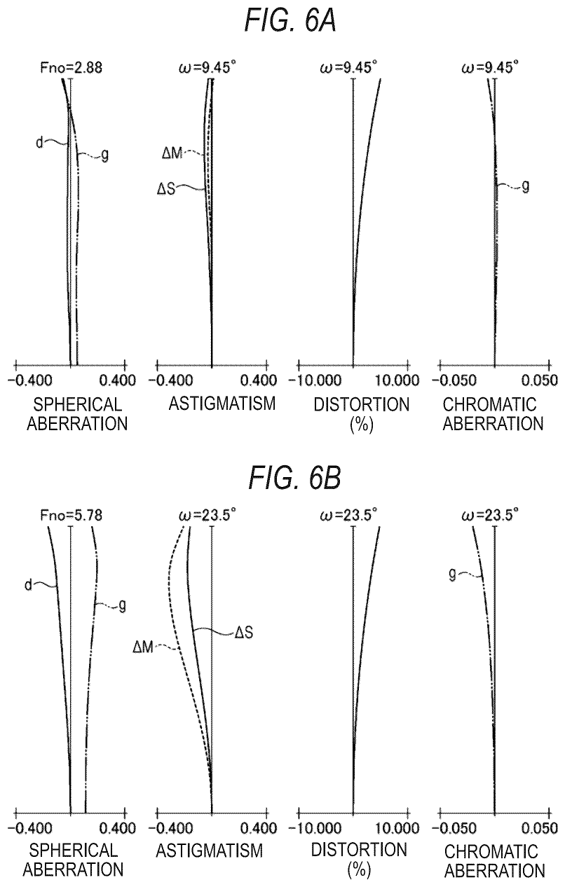

FIG. 5 shows cross-sectional views of the lens apparatus of Embodiment 3 at (a) the time of focusing on infinity and (b) the time of focusing on the closest distance (image pickup magnification β=−1.0). FIGS. 6A and 6B are aberration diagrams of the lens apparatus of Embodiment 3 at the time of focusing on infinity and at the time of focusing on the closest distance (image pickup magnification β=−1.0), respectively. The lens apparatus of Embodiment 3 is a lens apparatus with an aperture ratio of about 2.9.

The lens apparatus of Embodiment 3 includes, in order from the object side to the image side, a first lens unit L1 having a positive refractive power, a second lens unit L2 having a negative refractive power, a third lens unit L3 having a positive refractive power, a fourth lens unit L4 having a positive refractive power, and a fifth lens unit L5 having a negative refractive power.

In focusing from infinity to a close distance, the second lens unit L2 moves toward the image side and the fourth lens unit L4 moves toward the object side along different loci. The first lens unit L1 does not move for focusing.

The first lens unit L1 is composed of, in order from the object side to the image side, a positive lens, a cemented lens composed of a positive lens and a negative lens, and a meniscus positive lens convex to the object side.

The second lens unit L2 is composed of, in order from the object side to the image side, a negative lens and a cemented lens including a positive lens and a negative lens.

The third lens unit L3 is composed of, in order from the object side to the image side, a cemented lens composed of a positive lens and a meniscus negative lens concave to the object side, and a meniscus positive lens concave to the object side.

The fourth lens unit L4 is composed of, in order from the object side to the image side, a positive lens and a cemented lens composed of a positive lens and a meniscus negative lens concave to the object side.

The fifth lens unit L5 is composed of, in order from the object side to the image side, a negative lens, a positive lens, a negative lens, and a meniscus negative lens concave to the object side.

An aperture stop SP is disposed adjacent to the object side of the third lens unit L3.

Each of FIGS. 6A and 6B shows aberration diagrams at the time of focusing on infinity and at the time of focusing on the closest distance (image pickup magnification β=−1.0) of the lens apparatus of Embodiment 3. All aberrations are satisfactorily corrected.

Numerical values in Embodiment 3 corresponding to the inequalities (1) to (16) are shown in Table 1. The lens apparatus according to Embodiment 3 satisfies the inequalities (1) to (16), is small in size, can perform from the infinite-distance shooting to the close-up shooting with magnification ratio of 1:1, and has high optical performance.

### Embodiment 4

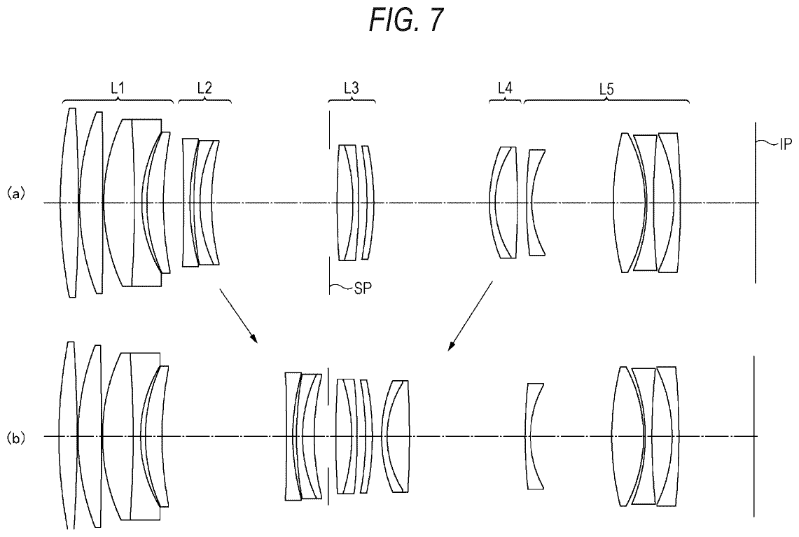

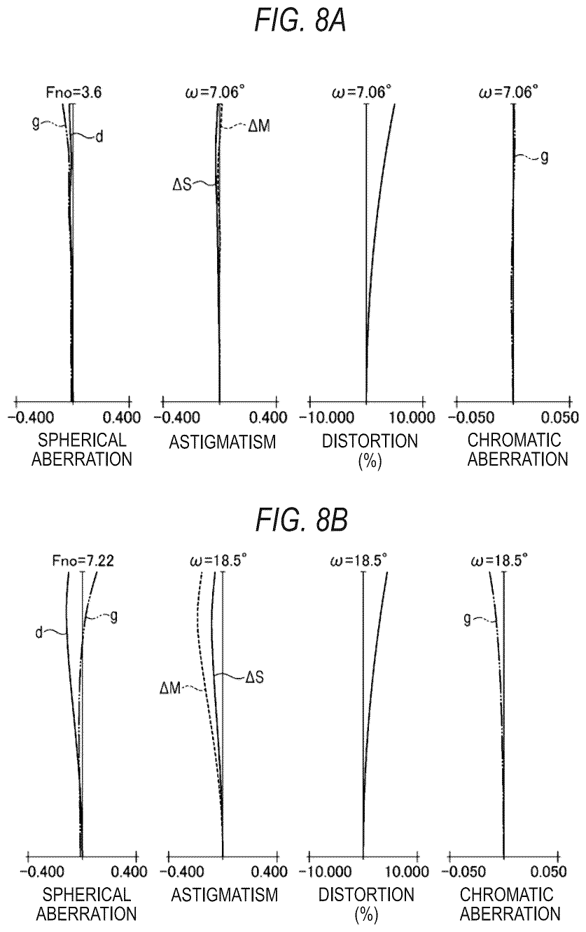

FIG. 7 shows cross-sectional views of the lens apparatus of Embodiment 4 at (a) the time of focusing on infinity and (b) the time of focusing on the closest distance (image pickup magnification β=−1.0). FIGS. 8A and 8B are aberration diagrams of the lens apparatus of Embodiment 4 at the time of focusing on infinity and at the time of focusing on the closest distance (image pickup magnification β=−1.0), respectively. The lens apparatus of Embodiment 4 is a lens apparatus with an aperture ratio of about 3.6.

The lens apparatus of Embodiment 4 includes, in order from the object side to the image side, a first lens unit L1 having a positive refractive power, a second lens unit L2 having a negative refractive power, a third lens unit L3 having a positive refractive power, a fourth lens unit L4 having a positive refractive power, and a fifth lens unit L5 having a negative refractive power.

In focusing from infinity to a close distance, the second lens unit L2 moves toward the image side and the fourth lens unit L4 moves toward the object side along different loci. The first lens unit L1 does not move for focusing.

The first lens unit L1 is composed of, in order from the object side to the image side, a positive lens, a positive lens, a cemented lens composed of a positive lens and a negative lens, and a meniscus positive lens convex to the object side.

The second lens unit L2 is composed of, in order from the object side to the image side, a negative lens, and a cemented lens composed of a meniscus negative lens convex to the object side and a meniscus positive lens convex to the object side.

The third lens unit L3 is composed of, in order from the object side to the image side, a cemented lens composed of a positive lens and a meniscus negative lens concave to the object side, and a meniscus positive lens concave to the object side.

The fourth lens unit L4 is composed of, in order from the object side to the image side, a cemented lens composed of a meniscus negative lens convex to the object side and a positive lens.

The fifth lens unit L5 is composed of, in order from the object side to the image side, a meniscus negative lens convex to the object side, a positive lens, a negative lens, and a meniscus negative lens concave to the object side.

An aperture stop SP is disposed adjacent to the object side of the third lens unit L3.

Each of FIGS. 8A and 8B shows aberration diagrams at the time of focusing on infinity and at the time of focusing on the closest distance (image pickup magnification β=−1.0) of the lens apparatus of Embodiment 4. All aberrations are satisfactorily corrected.

Numerical values in Embodiment 4 corresponding to the inequalities (1) to (16) are shown in Table 1. The lens apparatus according to Embodiment 4 satisfies the inequalities (1) to (16), is small in size, can perform from the infinity image pickup to the magnification image pickup with magnification ratio of 1:1, and has high optical performance.

As described above, according to the embodiments, by appropriately setting the configuration of each lens unit, it is possible to obtain a lens apparatus which is small in size and can obtain high optical performance in image pickup from focusing on infinity to focusing on the closest distance.

### NUMERICAL EMBODIMENTS

Hereinafter, Numerical Embodiments 1 to 4 corresponding to Embodiments 1 to 4 will be described.

In each numerical Embodiment, ri is a radius of curvature of the i-th surface counted from the object side, di is a lens thickness or an air gap between the i-th surface and the (i+1)-th surface, and ndi and vdi are a refractive index and an Abbe number with respect to the d-line of the optical member between the i-th surface and the (i+1)-th surface, respectively.

“*” attached to the right of the surface number indicates that the surface is an aspherical surface. The shape of the aspherical surface is described in the following formula,

$$X = \frac{\frac{{H}^{2}}{R}}{1 + \sqrt{1 - ( 1 + K ) {( \frac{H}{R} )}^{2}}} + A 4 {H}^{4} + A 6 {H}^{6} + A 8 {H}^{8} + A 10 {H}^{10} + A 12 {H}^{12}$$

where assuming that X axis is defined in the optical axis direction, H axis is defined in the direction perpendicular to the optical axis, the traveling direction of light is positive, R is a paraxial radius of curvature, K is a conic constant, and A4, A6, A8, A10, and A12 are aspherical surface coefficients. Here, “e-x” means “×10^{-x}”.

In Numerical Embodiments 1 to 4, BF represents the back focus, and the angle of view represents the half angle of view obtained by the paraxial calculation. The value of the surface interval is shown for a position where the in-focus position is at infinity and the image pickup magnification is magnification ratio of 1:1 (β=−1.0).

### Numerical Embodiment 1

Unit mm
Surface Data

| Surface number | r | d | nd | vd |
|---|---|---|---|---|
| 1 | 103.983 | 4.53 | 1.87070 | 40.7 |
| 2 | −184.034 | 0.15 | | |
| 3 | 43.663 | 6.17 | 1.59282 | 68.6 |
| 4 | −111.507 | 1.00 | 1.84666 | 23.8 |
| 5 | 24.819 | 2.00 | | |
| 6 | 27.248 | 4.63 | 1.95375 | 32.3 |
| 7 | 239.865 | (variable) | | |
| 8* | −67.582 | 1.00 | 1.85135 | 40.1 |
| 9* | 34.307 | 1.83 | | |
| 10 | 168.237 | 1.00 | 2.00100 | 29.1 |
| 11 | 31.785 | 3.70 | 1.95906 | 17.5 |
| 12 | 3779.617 | (variable) | | |
| 13(stop) | ∞ | 0.98 | | |
| 14 | 79.946 | 5.48 | 1.52841 | 76.5 |
| 15 | −30.197 | 1.00 | 1.87070 | 40.7 |
| 16 | −61.003 | 1.49 | | |
| 17 | −248.944 | 2.74 | 1.90043 | 37.4 |
| 18 | −51.456 | (variable) | | |
| 19 | 41.650 | 4.12 | 1.69680 | 55.5 |
| 20 | −66.566 | 0.23 | | |
| 21 | −55.727 | 1.00 | 1.95906 | 17.5 |
| 22 | −133.795 | (variable) | | |
| 23 | −335.955 | 0.99 | 1.49700 | 81.5 |
| 24 | 21.640 | 9.85 | | |
| 25 | −27.920 | 4.78 | 1.57501 | 41.5 |
| 26 | −16.627 | 0.77 | | |
| 27 | −15.890 | 1.50 | 2.05090 | 26.9 |
| 28 | −79.195 | 0.68 | | |
| 29 | −549.909 | 7.97 | 1.66680 | 33.0 |
| 30 | −27.242 | 10.00 | | |
| Image plane | ∞ | | | |

Aspherical Data
Eighth Surface
K = 0.00000e 00 A4 = 1.31836e−05 A6 = 1.36454e−07 A8 = 1.03998e−09
A10 = −4.48037e−12 A12 = 8.10808e−15
Ninth Surface
K = 0.00000e 00 A4 = 8.31737e−06 A6 = −1.27231e−07 A8 = 8.92540e−10
A10 = −3.61625e−12 A12 = 6.33924e−15
Various Data

| Focal length | 87.89 | |
|---|---|---|
| F number | 2.88 | |
| Half angle of view | 13.83 | |
| Image Height | 21.64 | |
| Total lens length | 119.15 | |
| BF | 10.00 | |
| In-focus position | Infinite distant | β = −1.0 |
| d7 | 3.18 | 19.51 |
| d12 | 18.33 | 1.99 |
| d18 | 16.04 | 1.99 |
| d22 | 1.99 | 16.00 |

Lens Unit Data

| Unit | Leading Surface | Focal length |
|---|---|---|
| 1 | 1 | 45.08 |
| 2 | 8 | −30.38 |
| 3 | 13 | 43.96 |
| 4 | 19 | 58.27 |
| 5 | 23 | −32.78 |

### Numerical Embodiment 2

Unit mm
Surface Data

| Surface number | r | d | nd | vd |
|---|---|---|---|---|
| 1 | 97.467 | 4.53 | 1.87070 | 40.7 |
| 2 | −195.208 | 0.15 | | |
| 3 | 42.094 | 6.36 | 1.61800 | 63.4 |
| 4 | −95.780 | 1.00 | 1.92119 | 24.0 |
| 5 | 24.777 | 1.73 | | |
| 6 | 26.932 | 4.87 | 1.95375 | 32.3 |
| 7 | 724.484 | (variable) | | |
| 8* | −62.361 | 1.00 | 1.85135 | 40.1 |
| 9* | 32.346 | 1.59 | | |
| 10 | 91.407 | 1.00 | 2.05090 | 26.9 |
| 11 | 27.293 | 3.90 | 1.95906 | 17.5 |
| 12 | 514.495 | (variable) | | |
| 13(stop) | ∞ | 1.39 | | |
| 14 | 95.300 | 4.95 | 1.65844 | 50.9 |
| 15 | −31.981 | 1.00 | 2.00100 | 29.1 |
| 16 | −73.646 | 1.49 | | |
| 17 | −65.307 | 2.27 | 1.89286 | 20.4 |
| 18 | −39.989 | (variable) | | |
| 19 | 56.449 | 2.98 | 1.72916 | 54.7 |
| 20 | −805.813 | 0.04 | | |
| 21 | 109.269 | 4.11 | 1.56732 | 42.8 |
| 22 | −39.994 | 1.00 | 1.95906 | 17.5 |
| 23 | −98.885 | (variable) | | |
| 24 | −393.591 | 0.99 | 1.72916 | 54.7 |
| 25 | 24.393 | 2.76 | | |
| 26 | 26.435 | 7.67 | 1.59551 | 39.2 |
| 27 | −36.586 | 0.50 | | |
| 28 | −57.076 | 1.50 | 2.05090 | 26.9 |
| 29 | 80.816 | 6.47 | | |
| 30 | −20.180 | 1.50 | 1.72916 | 54.7 |
| 31 | −39.649 | 14.22 | | |
| Image plane | ∞ | | | |

Aspherical Data
Eighth Surface
K = 0.00000e 00 A4 = 1.18759e−05 A6 = −7.30033e−08 A8 = 3.86835e−10
A10 = −1.35436e−12 A12 = 2.47967e−15
Ninth Surface
K = 0.00000e 00 A4 = 4.69570e−06 A6 = −5.74538e−08 A8 = 1.92993e−10
A10 = −3.64909e−13 A12 = 8.48019e−16
Various Data

| Focal length | 87.15 | |
|---|---|---|
| F number | 2.88 | |
| Half angle of view | 13.94 | |
| Image Height | 21.64 | |
| Total lens length | 119.29 | |
| BF | 14.22 | |
| In-focus position | Infinite distant | β = −1.0 |
| d7 | 3.03 | 18.19 |
| d12 | 17.26 | 2.09 |
| d18 | 16.06 | 1.99 |
| d23 | 2.00 | 16.02 |

Lens Unit Data

| Unit | Leading Surface | Focal length |
|---|---|---|
| 1 | 1 | 43.99 |
| 2 | 8 | −29.73 |
| 3 | 13 | 54.90 |
| 4 | 19 | 53.37 |
| 5 | 24 | −21.84 |

### Numerical Embodiment 3

Unit mm
Surface Data

| Surface number | r | d | nd | vd |
|---|---|---|---|---|
| 1 | 109.854 | 5.22 | 1.83481 | 42.7 |
| 2 | −236.046 | 0.20 | | |
| 3 | 57.174 | 7.51 | 1.72916 | 54.7 |
| 4 | −166.228 | 1.60 | 1.92119 | 24.0 |
| 5 | 30.853 | 2.03 | | |
| 6 | 32.384 | 6.98 | 1.78880 | 28.4 |
| 7 | 269.875 | (variable) | | |
| 8* | −123.132 | 1.50 | 1.85135 | 40.1 |
| 9* | 47.257 | 0.91 | | |
| 10 | 63.035 | 5.21 | 1.95906 | 17.5 |
| 11 | −107.156 | 1.50 | 1.90110 | 27.1 |
| 12 | 67.626 | (variable) | | |
| 13(stop) | ∞ | 1.79 | | |
| 14 | 128.269 | 6.10 | 1.55200 | 70.7 |
| 15 | −43.608 | 1.40 | 1.90043 | 37.4 |
| 16 | −84.869 | 1.58 | | |
| 17 | −95.612 | 2.55 | 2.05090 | 26.9 |
| 18 | −60.698 | (variable) | | |
| 19 | 51.383 | 4.14 | 1.49700 | 81.5 |
| 20 | −161.660 | 0.05 | | |
| 21 | 201.195 | 3.97 | 1.48749 | 70.2 |
| 22 | −51.251 | 1.40 | 2.05090 | 26.9 |
| 23 | −106.004 | (variable) | | |
| 24 | −315.430 | 1.20 | 1.69680 | 55.5 |
| 25 | 30.445 | 15.20 | | |
| 26 | 72.961 | 7.01 | 1.85478 | 24.8 |
| 27 | −48.701 | 0.50 | | |
| 28 | −59.601 | 1.50 | 1.95906 | 17.5 |
| 29 | 310.340 | 4.49 | | |
| 30 | −43.864 | 1.70 | 1.51633 | 64.1 |
| 31 | −750.000 | 19.55 | | |
| Image plane | ∞ | | | |

Aspherical Data
Eighth Surface
K = 0.00000e 00 A4 = −1.73213e−06 A6 = 1.25288e−08 A8 = −5.19847e−11
A10 = 9.72487e−14 A12 = −5.09355e−17
Ninth Surface
K = 0.00000e 00 A4 = −2.96560e−06 A6 = 1.25389e−08 A8 = −5.16581e−11
A10 = 7.87152e−14 A12 = 2.45418e−18
Various Data

| Focal length | 130.02 | |
|---|---|---|
| F number | 2.88 | |
| Half angle of view | 9.45 | |
| Image Height | 21.64 | |
| Total lens length | 160.82 | |
| BF | 19.55 | |
| In-focus position | Infinite distant | β = −1.0 |
| d7 | 3.80 | 25.12 |
| d12 | 25.17 | 3.86 |
| d18 | 23.05 | 1.99 |
| d23 | 2.00 | 23.01 |

Lens Unit Data

| Unit | Leading Surface | Focal length |
|---|---|---|
| 1 | 1 | 63.97 |
| 2 | 8 | −43.59 |
| 3 | 13 | 76.04 |
| 4 | 19 | 71.52 |
| 5 | 24 | −36.63 |

### Numerical Embodiment 4

Unit mm
Surface Data

| Surface number | r | d | nd | vd |
|---|---|---|---|---|
| 1 | 134.630 | 4.88 | 1.48749 | 70.2 |
| 2 | −389.191 | 0.30 | | |
| 3 | 67.287 | 6.30 | 1.49700 | 81.6 |
| 4 | −1742.493 | 0.30 | | |
| 5 | 52.818 | 8.30 | 1.49700 | 81.6 |
| 6 | −316.928 | 2.00 | 1.63930 | 44.9 |
| 7 | 36.742 | 1.34 | | |
| 8 | 45.751 | 4.50 | 1.48749 | 70.2 |
| 9 | 96.570 | (variable) | | |
| 10* | −3240.956 | 1.70 | 1.85135 | 40.1 |
| 11* | 55.187 | 1.07 | | |
| 12 | 96.726 | 1.60 | 1.69680 | 55.5 |
| 13 | 38.783 | 3.18 | 1.92286 | 20.9 |
| 14 | 67.248 | (variable) | | |
| 15(stop) | ∞ | 2.10 | | |
| 16 | 250.674 | 4.29 | 1.74950 | 35.3 |
| 17 | −52.205 | 1.50 | 1.92119 | 24.0 |
| 18 | −141.305 | 2.30 | | |
| 19 | −82.174 | 1.83 | 2.00100 | 29.1 |
| 20 | −74.664 | (variable) | | |
| 21 | 39.213 | 1.50 | 1.95375 | 32.3 |
| 22 | 26.768 | 6.06 | 1.59282 | 68.6 |
| 23 | −244.081 | (variable) | | |
| 24 | 128.599 | 1.50 | 1.72916 | 54.7 |
| 25 | 28.352 | 22.12 | | |
| 26 | 76.276 | 8.61 | 1.60342 | 38.0 |
| 27 | −39.606 | 0.50 | | |
| 28 | −47.291 | 1.80 | 1.48749 | 70.2 |
| 29 | 183.056 | 5.51 | | |
| 30 | −42.328 | 1.80 | 1.48749 | 70.2 |
| 31 | −198.044 | 20.35 | | |
| Image plane | ∞ | | | |

Aspherical Data
Tenth Surface
K = 0.00000e 00 A4 = −7.37263e−06 A6 = 3.20696e−08 A8 = −1.09146e−10
A10 = 2.25548e−13 A12 = −2.03478e−16
Eleventh Surface
K = 0.00000e 00 A4 = −7.83337e−06 A6 = 3.20915e−08 A8 = −1.11248e−10
A10 = 2.34738e−13 A12 = −2.18317e−16
Various Data

| Focal length | 174.62 | |
|---|---|---|
| F number | 3.60 | |
| Half angle of view | 7.06 | |
| Image Height | 21.64 | |
| Total lens length | 188.69 | |
| BF | 20.35 | |
| In-focus position | Infinite distant | β = −1.0 |
| d9 | 5.50 | 33.81 |
| d14 | 32.08 | 3.77 |
| d20 | 31.41 | 2.50 |
| d23 | 2.50 | 31.37 |

Lens Unit Data

| Unit | Leading Surface | Focal length |
|---|---|---|
| 1 | 1 | 85.52 |
| 2 | 10 | −60.56 |
| 3 | 15 | 133.92 |
| 4 | 21 | 74.78 |
| 5 | 24 | −53.54 |

Table 1 shows values of Embodiments 1 to 4 corresponding to the inequalities (1) to (16).

TABLE 1

| Inequality | | Embodiment 1 | Embodiment 2 | Embodiment 3 | Embodiment 4 |
|---|---|---|---|---|---|
| (1) | f3/f | 0.500 | 0.630 | 0.585 | 0.767 |
| (2) | f4/f | 0.663 | 0.612 | 0.550 | 0.428 |
| (3) | f5/f | −0.373 | −0.251 | −0.282 | −0.307 |
| (4) | f5/f3 | −0.746 | −0.398 | −0.482 | −0.400 |
| (5) | f5/f4 | −0.563 | −0.409 | −0.512 | −0.716 |
| (6) | f3/f4 | 0.754 | 1.029 | 1.063 | 1.791 |
| (7) | f2/f3 | −0.691 | −0.541 | −0.573 | −0.452 |
| (8) | f/\|f12\| | 0.189 | 0.171 | 0.041 | 0.206 |
| (9) | f3B/f3A | 0.681 | 1.081 | 1.053 | 4.510 |
| (10) | f5A/f5 | 1.247 | 1.441 | 1.086 | 0.938 |
| (11) | sk/TL | 11.940 | 8.389 | 8.224 | 9.274 |
| (12) | MD2/TL | 1.635 | 1.066 | 1.090 | 1.392 |
| (13) | MD4/TL | 1.402 | 0.986 | 1.074 | 1.419 |
| (14) | ES2 | −3.761 | −3.896 | −4.129 | −4.126 |
| (15) | ES4 | 2.773 | 2.807 | 2.759 | 2.705 |
| (16) | G5ASF | 0.879 | 0.883 | 0.824 | 1.566 |
| | f | 87.834 | 87.152 | 130.022 | 174.619 |
| | f1 | 45.076 | 43.988 | 63.971 | 85.523 |
| | f2 | −30.382 | −29.728 | −43.589 | −60.563 |
| | f3 | 43.958 | 54.900 | 76.037 | 133.921 |
| | f4 | 58.266 | 53.370 | 71.519 | 74.784 |
| | f5 | −32.782 | −21.838 | −36.625 | −53.539 |
| | f12 | −464.515 | −510.873 | −3193.439 | 847.140 |
| | f3A | 105.134 | 102.513 | 144.789 | 161.342 |
| | f3B | 71.564 | 110.845 | 152.474 | 727.629 |
| | f5A | −40.869 | −31.470 | −39.790 | −50.197 |
| | sk | 119.339 | 119.294 | 160.816 | 188.693 |
| | TL | 9.995 | 14.221 | 19.554 | 20.346 |
| | MD2 | 16.337 | 15.161 | 21.316 | 28.312 |
| | MD4 | 14.012 | 14.027 | 21.009 | 28.869 |

(Image pickup apparatus)

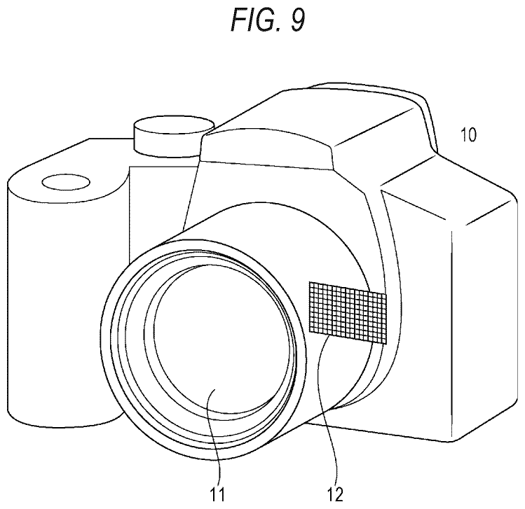

Next, an Embodiment of a digital still camera using the lens apparatus of the present disclosure as an image pickup optical system will be described with reference to FIG. 9.

### EMBODIMENT

In FIG. 9, reference numeral 10 denotes a camera body, reference numeral 11 denotes an image pickup optical system configured by any of the lens apparatuses described in Embodiments 1-4. Reference numeral 12 is a solid-state image pickup element (photoelectric conversion element), such as a CCD sensor or CMOS sensor, built into the camera body itself to receive an image formed by the image pickup optical system 11. The camera body 10 may be a so-called single-lens reflex camera with a quick-return mirror, or a so-called mirrorless camera without a quick-return mirror.

As described above, by applying the lens apparatus of the present disclosure to an image pickup apparatus such as a digital still camera, it is possible to obtain an image pickup apparatus that is small in size, can perform from the infinite-distance shooting to the close-up shooting with magnification ratio of 1:1, and has a high optical performance.

According to the present disclosure, it is possible to provide a lens apparatus which is small in size, can perform from the infinite-distance shooting to the close-up shooting with magnification ratio of 1:1, and which has high optical performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-031357, filed Feb. 28, 2025, which is hereby incorporated by reference herein in its entirety.

What is claimed is:

1. A lens apparatus comprising, in order from an object side to an image side: a first lens unit having a positive refractive power; a second lens unit having a negative refractive power; a third lens unit having a positive refractive power; a fourth lens unit having a positive refractive power; and a fifth lens unit having a negative refractive power, in which each distance between adjacent lens units changes during focusing,
wherein, the first lens unit does not move for focusing, the second lens unit and the fourth lens unit move for focusing, and
wherein the following inequalities are satisfied,
$$0. 44 < f 3 / f < 0.8$$
$$0 < f 4 / f < 0.72$$
where f represents a focal length of the lens apparatus, f3 represents a focal length of the third lens unit, and f4 represents a focal length of the fourth lens unit.

2. The lens apparatus according to claim 1, wherein the following inequality is satisfied,
$$- 0.50 < f 5 / f < - 0.15$$
where f5 represents a focal length of the fifth lens unit.

3. The lens apparatus according to claim 1, wherein the following condition is satisfied,
$$- 0.85 < f 5 / f 3 < - 0.3$$
where f5 represents a focal length of the fifth lens unit.

4. The lens apparatus according to claim 1, wherein the following condition is satisfied,
$$- 0.80 < f 5 / f 4 < - 0.3$$
where f5 represents a focal length of the fifth lens unit.

5. The lens apparatus according to claim 1, wherein the following condition is satisfied,
$$0.65 < f 3 / f 4 < 2.00 .$$

6. The lens apparatus according to claim 1, wherein the following condition is satisfied,
$$- 0.80 < f 2 / f 3 < - 0.35$$
where f2 represents a focal length of the second lens unit.

7. The lens apparatus according to claim 1, wherein the following condition is satisfied,
$$0 < f / \vert f 12 \vert < 0.3$$
where f12 represents a combined focal length of the first lens unit and the second lens unit at a time of focusing on infinity.

8. The lens apparatus according to claim 1, wherein the following condition is satisfied,
$$0. 40 < f 3 B / f 3 A < 5.$$
where f3A represents a focal length of a lens element G3A disposed at a most object side in the third lens unit, and f3B represents a focal length of all lens elements G3B disposed in the image side of the lens element G3A in the third lens unit.

9. The lens apparatus according to claim 1, wherein the following condition is satisfied,
$$0.8 < f 5 A / f 5 < 1.6$$
where f5 represents a focal length of the fifth lens unit and f5A represents a focal length of a lens element G5A disposed at a most object side in the fifth lens unit.

10. The lens apparatus according to claim 1, wherein the following condition is satisfied,
$$6. < s k / T L < 14.0$$
where sk represents a back focus at a time of focusing on infinity, and TL represents a total optical length of the lens apparatus.

11. The lens apparatus according to claim 1, wherein the following condition is satisfied,
$$0.9 < MD 2 / TL < 1.8$$
where MD2 represents a distance in which the second lens unit moves along an optical axis during focusing from infinity to a closest distance, and TL represents a total optical length of the lens apparatus.

12. The lens apparatus according to claim 1, wherein the following condition is satisfied,
$$0.8 < MD 4 / TL < 1.6$$
where MD4 represents a distance in which the fourth lens unit moves along an optical axis during focusing from infinity to a closest distance, and TL represents a total optical length of the lens apparatus.

13. The lens apparatus according to claim 1, wherein the following condition is satisfied,
$$- 5. < ES 2 < - 3.$$
where ES2 represents a focus sensitivity of the second lens unit at a time of focusing on infinity.

14. The lens apparatus according to claim 1, wherein the following condition is satisfied,
$$2. < E S 4 < 3.5$$
where ES4 represents a focus sensitivity of the fourth lens unit at a time of focusing on infinity.

15. The lens apparatus according to claim 1, wherein the following condition is satisfied,
$$0.7 < G 5 A S F < 2.00$$
where G5ASF represents a shape factor of a lens element G5A disposed at a most object side in the fifth lens unit.

16. The lens apparatus according to claim 1, wherein, during focusing from infinity to a close distance, the second lens unit moves toward the image side and the fourth lens unit moves toward the object side along different loci.

17. An image pickup apparatus comprising: a lens apparatus; and an image pickup element configured to receive an image formed by the lens apparatus,
wherein the lens apparatus includes, in order from an object side to an image side: a first lens unit having a positive refractive power; a second lens unit having a negative refractive power; a third lens unit having a positive refractive power; a fourth lens unit having a positive refractive power; and a fifth lens unit having a negative refractive power, in which each distance between adjacent lens units changes during focusing,
wherein, the first lens unit does not move for focusing, the second lens unit and the fourth lens unit move for focusing, and
wherein the following inequalities are satisfied,
$$0. 44 < f 3 / f < 0.8$$
$$0 < f 4 / f < 0.72$$
where f represents a focal length of the lens apparatus, f3 represents a focal length of the third lens unit, and f4 represents a focal length of the fourth lens unit.
